(19) United States
(12) Patent Application Publication
(10) Pub. No.: US 2025/0137839 A1
(43) Pub. Date: May 1, 2025

(54) VEHICLE VIBRATION EXTRACTION SYSTEM, VEHICLE VIBRATION EXTRACTION APPARATUS, AND VEHICLE VIBRATION EXTRACTION METHOD

(71) Applicant: NEC Corporation, Tokyo (JP)

(72) Inventors: Daisuke IKEFUJI, Tokyo (JP); Hemant Shivsagar PRASAD, Tokyo (JP)

(73) Assignee: NEC Corporation, Tokyo (JP)

(21) Appl. No.: 18/912,779

(22) Filed: Oct. 11, 2024

(30) Foreign Application Priority Data
Oct. 27, 2023 (JP) 2023-184499

(51) Int. Cl. G01H 9/00; G06F 17/14

(52) U.S. Cl. CPC G01H 9/004; G06F 17/145

(57) ABSTRACT

A vehicle vibration extraction system according to the present disclosure includes: at least one memory configured to store instructions; and at least one processor configured, by executing the instructions, to acquire measurement data of vibration generated on a road from a sensing apparatus that measures vibration generated on the road by using an optical fiber buried in the road, and extract a vehicle vibration component from the measurement data by performing frequency filtering on the measurement data by using a band limiting filter having a passband associated to the road and a road surface state of the road.

### INCORPORATION BY REFERENCE

This application is based upon and claims the benefit of priority from Japanese patent application No. 2023-184499, filed on Oct. 27, 2023, the disclosure of which is incorporated herein in its entirety by reference.

### TECHNICAL FIELD

The present disclosure relates to a vehicle vibration extraction system, a vehicle vibration extraction apparatus, and a vehicle vibration extraction method.

### BACKGROUND ART

By optical fiber sensing using an optical fiber buried in a road as a line sensor, a sensing apparatus connected to an optical fiber can measure vehicle vibration of a vehicle traveling on a road over an entire section in which an optical fiber is buried. Further, the sensing apparatus can visualize a trajectory of a vehicle by generating measurement data representing intensity of the measured vehicle vibration as a graph of a distance of the optical fiber from the sensing apparatus and a time. Further, by using an existing optical fiber for communication as an optical fiber, it is possible to introduce a system for monitoring a vehicle at low cost.

However, the vibration measured by the optical fiber sensing includes a noise component in addition to a vehicle vibration component. Therefore, in order to monitor the vehicle, processing of extracting the vehicle vibration component from the measurement data of the vibration measured by the optical fiber sensing is required.

As a related art, for example, Japanese Unexamined Patent Application Publication No. H07-198471 discloses a technique for detecting amplitude and a frequency of a vibration source such as a vehicle by performing frequency filtering on return light from an optical fiber by using a low-pass filter or the like.

### SUMMARY

However, a noise component included in vibration measured by optical fiber sensing differs in a characteristic for each road, and also differs in a characteristic for each road surface state even for the same road.

Therefore, there is a problem that a vehicle vibration component cannot be extracted with high accuracy even when measurement data are performed frequency filtering by using the same filter, regardless of the road or the surface state of the road.

Thus, in view of the problem described above, an example object of the present disclosure is to provide a vehicle vibration extraction system, a vehicle vibration extraction apparatus, and a vehicle vibration extraction method that are capable of extracting a vehicle vibration component with high accuracy from measurement data of vibration measured by optical fiber sensing.

In a first example aspect, a vehicle vibration extraction system according to the present disclosure includes:
at least one memory configured to store instructions; and
at least one processor configured, by executing the instructions, to
acquire measurement data of vibration generated on a road from a sensing apparatus that measures vibration generated on the road by using an optical fiber buried in the road, and
extract a vehicle vibration component from the measurement data by performing frequency filtering on the measurement data by using a band limiting filter having a passband associated to the road and a road surface state of the road.

In a second example aspect, a vehicle vibration extraction apparatus according to the present disclosure includes:
at least one memory configured to store instructions; and
at least one processor configured, by executing the instructions, to
acquire measurement data of vibration generated on a road from a sensing apparatus that measures vibration generated on the road by using an optical fiber buried in the road, and
extract a vehicle vibration component from the measurement data by performing frequency filtering on the measurement data by using a band limiting filter having a passband associated to the road and a road surface state of the road.

In a third example aspect, a vehicle vibration extraction method according to the present disclosure is a vehicle vibration extraction method executed by a vehicle vibration extraction apparatus, the vehicle vibration extraction method includes:
acquiring measurement data of vibration generated on a road from a sensing apparatus that measures vibration generated on the road by using an optical fiber buried in the road; and
extracting a vehicle vibration component from the measurement data by performing frequency filtering on the measurement data by using a band limiting filter having a passband associated to the road and a road surface state of the road.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a diagram describing a basic principle of the present disclosure;

FIG. 2 is a diagram illustrating a schematic configuration example of a vehicle vibration extraction system according to the present disclosure;

FIG. 3 is a diagram describing a schematic operation example of the vehicle vibration extraction system according to the present disclosure;

FIG. 4 is a flowchart describing an example of a flow of schematic operation of the vehicle vibration extraction system according to the present disclosure;

FIG. 5 is a diagram illustrating a schematic configuration example of the vehicle vibration extraction system according to the present disclosure;

FIG. 6 is a diagram describing a schematic operation example of the vehicle vibration extraction system according to the present disclosure;

FIG. 7 is a flowchart describing an example of a flow of schematic operation of the vehicle vibration extraction system according to the present disclosure;

FIG. 8 is a diagram illustrating a schematic configuration example of the vehicle vibration extraction system according to the present disclosure;

FIG. 9 is a diagram describing a schematic operation example of the vehicle vibration extraction system according to the present disclosure;

FIG. 10 is a diagram describing a schematic operation example of the vehicle vibration extraction system according to the present disclosure;

FIG. 11 is a diagram describing a schematic operation example of the vehicle vibration extraction system according to the present disclosure;

FIG. 12 is a diagram illustrating an example of an image acquired from measurement data in a case where a road is an expressway X in the vehicle vibration extraction system according to the present disclosure;

FIG. 13 is a diagram illustrating a schematic configuration example of the vehicle vibration extraction system according to the present disclosure.

FIG. 14 is a diagram describing a schematic operation example of the vehicle vibration extraction system according to the present disclosure;

FIG. 15 is a diagram illustrating an example of a power difference, in a frequency domain, between measurement data when a vehicle is traveling and when a vehicle is not traveling in the vehicle vibration extraction system according to the present disclosure;

FIG. 16 is a diagram illustrating a schematic configuration example of the vehicle vibration extraction system according to the present disclosure; and

FIG. 17 is a block diagram illustrating a hardware configuration example of a computer that achieves a vehicle vibration extraction apparatus according to the present disclosure.

### EXAMPLE EMBODIMENT

Hereinafter, example embodiments of the present disclosure will be described with reference to the drawings. Note that, the following description and the drawings are omitted and simplified as appropriate for clarity of description. Further, in each of the following drawings, the same elements are denoted by the same reference signs, and redundant descriptions are omitted as necessary. Further, a specific numerical value and the like indicated below is merely an example for facilitating understanding of the present disclosure, and is not limited thereto.

### Basic Principle of the Present Disclosure

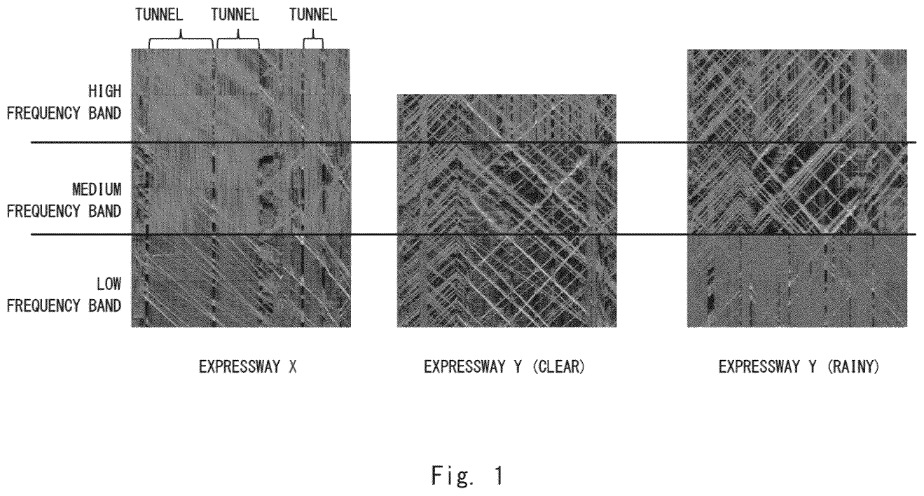

Before describing each example embodiment of the present disclosure, a basic principle of the present disclosure will be described with reference to FIG. 1.

As described above, a sensing apparatus can visualize a trajectory of a vehicle by generating measurement data representing intensity of vehicle vibration measured by optical fiber sensing as a graph of a distance of an optical fiber from the sensing apparatus and a time. However, vibration measured by the optical fiber sensing includes a noise component in addition to a vehicle vibration component.

A left figure in FIG. 1 illustrates three pieces of measurement data acquired by dividing measurement data of vibration measured by the optical fiber sensing by using an optical fiber buried in an expressway X including a tunnel portion into each band of a low frequency band, a medium frequency band, and a high frequency band. Further, in each of the three pieces of measurement data, a horizontal axis illustrates the distance of the optical fiber from the sensing apparatus, and a vertical axis represents a time (the same in middle and right figures in FIG. 1).

Further, the middle figure in FIG. 1 illustrates three pieces of measurement data acquired by dividing, into each band similar to that in the left figure, measurement data of vibration measured when weather is clear weather (i.e., when a road surface state of an expressway Y is dry) by the optical fiber sensing using an optical fiber buried in the expressway Y not including the tunnel portion.

Further, the right figure in FIG. 1 illustrates three pieces of measurement data acquired by dividing, into each band similar to that in the left figure, measurement data of vibration measured when weather is rainy weather (i.e., when the road surface state of the expressway Y is wet) by the optical fiber sensing using the optical fiber buried in the expressway Y not including the tunnel portion.

Herein, in each piece of measurement data illustrated in FIG. 1, in a case where a vehicle is traveling on a road, a line indicates that the vehicle is traveling. For example, one vehicle traveling on a road is represented by one oblique line. Further, an inclination of the oblique line represents a traveling speed of a vehicle, and it means that the smaller the inclination of the oblique line, the higher the traveling speed of the vehicle.

For example, in a case of the expressway X, a large number of oblique lines can be acquired in the low frequency band.

In contrast, in a case of the expressway Y, when weather is clear weather, a large number of oblique lines can be acquired not only in the low frequency band but also in the medium frequency band and the high frequency band. However, when weather is rainy weather, a large number of oblique lines cannot be acquired in the low frequency band, and a large number of oblique lines can be acquired in the medium frequency band and the high frequency band.

In this way, it can be seen that a frequency at which the vehicle vibration component is dominant (in other words, the frequency at which the noise component is dominant) largely depends on a road, and also largely depends on the road surface state even on the same road.

Thus, in the present disclosure, the vehicle vibration component and the noise component included in the measurement data are separated with high accuracy by performing frequency filtering on the measurement data by using an optimum band limiting filter associated to a road and the road surface state of the road, and the vehicle vibration component is extracted from the measurement data with high accuracy.

Hereinafter, each example embodiment of the present disclosure will be described.

### First Example Embodiment

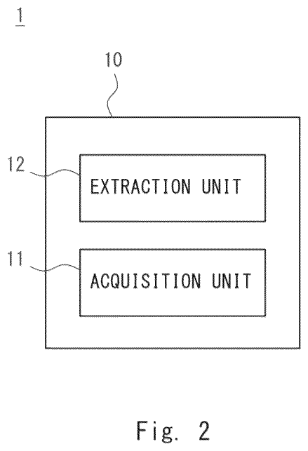

First, a schematic configuration example of a vehicle vibration extraction system 1 will be described with reference to FIG. 2.

The vehicle vibration extraction system 1 includes a vehicle vibration extraction apparatus 10.

The vehicle vibration extraction apparatus 10 includes an acquisition unit 11 and an extraction unit 12.

The acquisition unit 11 acquires measurement data of vibration generated on a road from a not-illustrated sensing apparatus. The sensing apparatus is an apparatus that performs optical fiber sensing for measuring vibrations generated on a road by using an optical fiber buried in the road, and is achieved by, for example, a distributed fiber optic sensing (DFOS) apparatus.

At this time, the acquisition unit 11 may input road information indicating a road, and determine the road, based on the input road information. Then, the acquisition unit 11 may acquire, from the sensing apparatus, the measurement data of the vibration generated on the road determined above. Note that, the road information may be input from an external apparatus, or may be manually input.

For example, the acquisition unit 11 acquires, from the sensing apparatus, measurement data (time-series data) representing intensity of vibration generated on a road as a graph of a distance of an optical fiber from the sensing apparatus and a time, as measurement data. An example of the measurement data is similar to that in FIG. 1.

In the following description, it is assumed that the acquisition unit 11 acquires, from the sensing apparatus, measurement data representing intensity of vibration generated on a road as a graph of the distance of the optical fiber from the sensing apparatus and a time, as measurement data.

The extraction unit 12 performs frequency filtering on the measurement data acquired by the acquisition unit 11 by using a band limiting filter having a passband associated to a road and a road surface state of the road. As a result, the extraction unit 12 extracts a vehicle vibration component from the measurement data.

At this time, the extraction unit 12 may input the road information indicating a road and road surface state information indicating the road surface state of the road, and determine the road and the road surface state of the road, based on the input road information and the input road surface state information. Then, the extraction unit 12 may perform frequency filtering by using the band limiting filter having the passband associated to the road and the road surface state of the road that are determined above. Note that, the road information and the road surface state information may be input from an external apparatus, or may be manually input. Alternatively, in place of the road surface state information, the extraction unit 12 may input weather information indicating weather of an area including a road, and determine the road surface state of the road, based on the input weather information.

Further, the extraction unit 12 may include a plurality of band limiting filters having passbands different from each other. Then, the extraction unit 12 may select and use a band limiting filter having the passband associated to a road and the road surface state of the road from among the plurality of band limiting filters. Further, the band limiting filter may be a band-pass filter or a low-pass filter, or may be another filter being capable of limiting a band of measurement data to the passband.

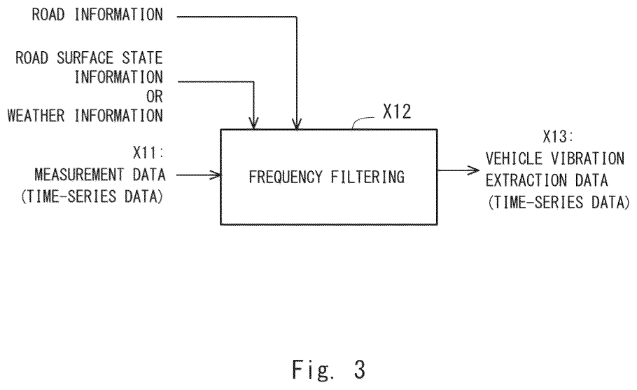

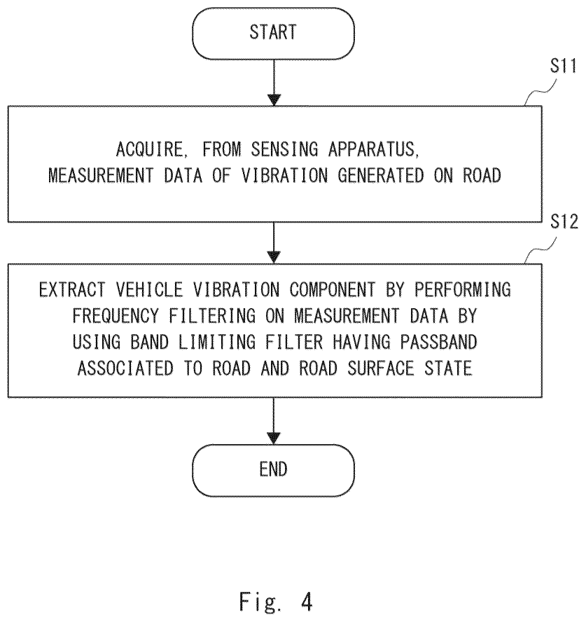

Subsequently, a schematic operation example of the vehicle vibration extraction system 1 will be described with reference to FIG. 3. Herein, it is assumed that a road indicated by the road information is a road R1, and the road surface state indicated by the road surface state information or the weather information is a road surface state r1 (the same in FIG. 4 hereinafter).

First, the acquisition unit 11 acquires, from the sensing apparatus, measurement data representing the intensity of the vibration generated on the road R1 as a graph of the distance of the optical fiber from the sensing apparatus and a time, as measurement data of the vibration generated on the road R1 (step X11).

Next, the extraction unit 12 performs frequency filtering on the measurement data by using the band limiting filter having the passband associated to the road R1 and the road surface state r1 of the road R1. As a result, the extraction unit 12 extracts the vehicle vibration component from the measurement data (step X12).

Thereafter, the extraction unit 12 outputs data of the vehicle vibration component extracted from the measurement data as vehicle vibration extraction data (time-series data) (step X13).

For example, in a case where the road R1 is an expressway X in FIG. 1, a large number of oblique lines can be acquired in a low frequency band. Therefore, the extraction unit 12 extracts the vehicle vibration component by performing frequency filtering on the measurement data by using the band limiting filter having the passband of the low frequency band.

Further, in a case where the road R1 is an expressway Y in FIG. 1 and the road surface state r1 is the road surface state (i.e., a dry state) at a time when weather is clear weather, a large number of oblique lines can be acquired in the low frequency band, a medium frequency band, and a high frequency band. Therefore, the extraction unit 12 extracts the vehicle vibration component by performing frequency filtering on the measurement data by using the band limiting filter having the passband of a band acquired by combining the low frequency band, the medium frequency band, and the high frequency band with one other.

Further, in a case where the road R1 is the expressway Y in FIG. 1 and the road surface state r1 is the road surface state (i.e., a wet state) at a time when weather is rainy weather, a large number of oblique lines can be acquired in the medium frequency band and the high frequency band. Therefore, the extraction unit 12 extracts the vehicle vibration component by performing frequency filtering on the measurement data by using the band limiting filter having the passband of a band acquired by combining the medium frequency band and the high frequency band with each other.

Subsequently, an example of a flow of schematic operation of the vehicle vibration extraction system 1 will be described with reference to FIG. 4.

First, the acquisition unit 11 acquires, from the sensing apparatus, measurement data representing the intensity of the vibration generated on the road R1 as a graph of the distance of the optical fiber from the sensing apparatus and a time, as measurement data of the vibration generated on the road R1 (step S11).

Thereafter, the extraction unit 12 extracts the vehicle vibration component from the measurement data by performing frequency filtering on the measurement data by using the band limiting filter having the passband associated to the road R1 and the road surface state r1 of the road R1 (step S12).

As described above, according to the first example embodiment, the acquisition unit 11 acquires, from the sensing apparatus, measurement data of vibration generated on a road. The extraction unit 12 extracts a vehicle vibration component from the measurement data by performing frequency filtering on the measurement data by using a band limiting filter having a passband associated to the road and a road surface state of the road. As a result, the measurement data can be performed frequency filtering by using an optimum band limiting filter associated to the road and the road surface state of the road, and thereby the vehicle vibration component can be extracted from the measurement data with high accuracy. As a result, a vehicle traveling on the road can be detected with high accuracy.

Note that, for example, there is a road, such as the expressway X in FIG. 1, in which a large number of tunnel portions are included, and a frequency in which the vehicle vibration component is dominant does not depend on the road surface state. For such a road, regardless of the road surface state of the road, the extraction unit 12 may perform frequency filtering on the measurement data by using the band limiting filter having a passband associated to the road.

### Second Example Embodiment

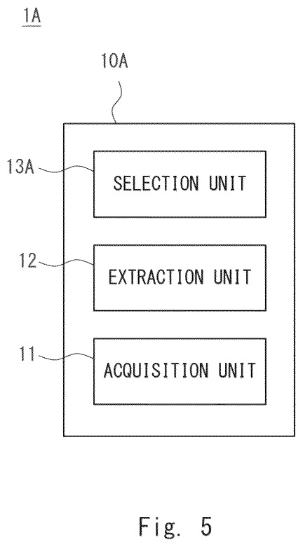

First, a schematic configuration example of a vehicle vibration extraction system 1A will be described with reference to FIG. 5.

The vehicle vibration extraction system 1A includes a vehicle vibration extraction apparatus 10A.

The vehicle vibration extraction apparatus 10A has a configuration in which a selection unit 13A is added as compared with the vehicle vibration extraction apparatus 10.

The selection unit 13A selects in advance a passband at a time when a road is in a road surface state for each road and for each road surface state of the road.

An extraction unit 12 performs frequency filtering on measurement data by using a band limiting filter having the passband selected in advance by the selection unit 13A according to a road and the road surface state of the road.

Herein, the selection unit 13A will be described specifically. For example, the selection unit 13A selects, for each road and for each road surface state of the road, the passband, based on a vibration propagation characteristic of the road at a time when the road is in the road surface state. For example, in a case where a road is a road R1 and a road surface state is a road surface state r1, the selection unit 13A may specify a band in which vehicle vibration is easily propagated on the road R1 at a time of the road surface state r1. Then, the selection unit 13A may select the specified band as the passband at a time when the road R1 is in the road surface state r1.

Alternatively, the selection unit 13A selects, for each road and for each road surface state of the road, the passband, based on the vibration propagation characteristic of the road and a vibration characteristic of a vehicle at a time when the road is in the road surface state. For example, in a case where a road is the road R1 and a road surface state is the road surface state r1, the selection unit 13A may specify a band in which the vehicle vibration is easily propagated on the road R1 at a time of the road surface state r1, and may also specify a band associated to the vibration characteristic (e.g., suspension vibration or the like) of a vehicle. Then, the selection unit 13A may select the band specified by both as the passband at a time when the road R1 is in the road surface state r1.

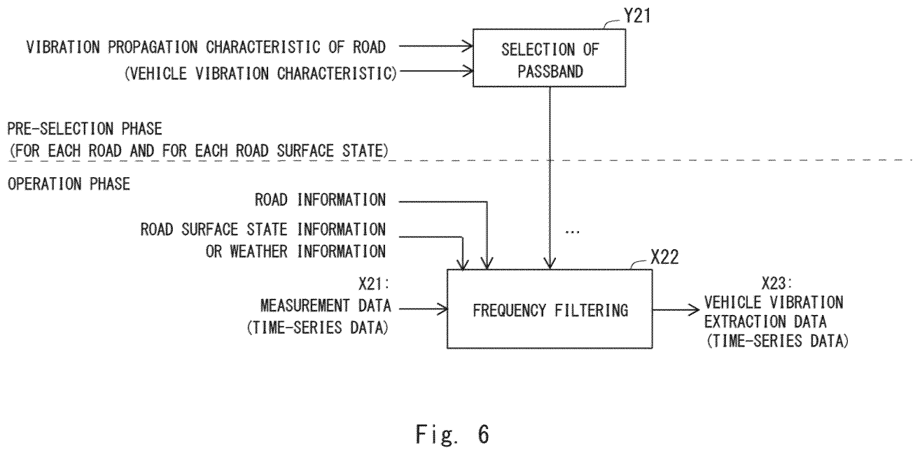

Subsequently, a schematic operation example of the vehicle vibration extraction system 1A will be described with reference to FIG. 6.

First, operation of a pre-selection phase will be described.

The selection unit 13A selects a passband at a time when a road is in a road surface state for each road and for each road surface state of the road (step Y21).

For example, the selection unit 13A selects the passband at a time when the road R1 is in the road surface state r1 as follows.

The selection unit 13A selects the passband, based on the vibration propagation characteristic of the road R1 at a time when the road R1 is in the road surface state r1. Alternatively, the selection unit 13A selects the passband, based on the vibration propagation characteristic of the road R1 and the vibration characteristic of a vehicle at a time when the road R1 is in the road surface state r1.

The selection unit 13A performs the above-described passband selection operation for each road and for each road surface state of the road.

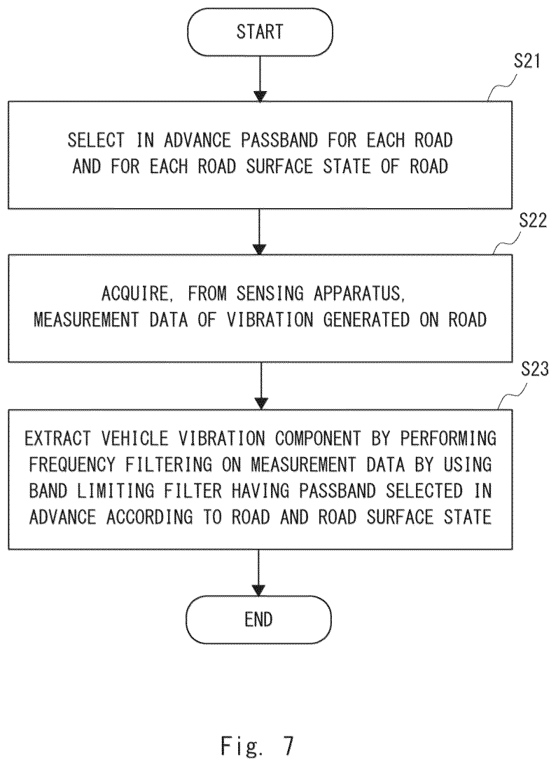

Subsequently, operation of an operation phase will be described. Herein, it is assumed that a road indicated by road information is the road R1, and a road surface state indicated by road surface state information or weather information is the road surface state r1 (the same applies in the following operation phase in FIG. 7).

First, an acquisition unit 11 acquires, from a sensing apparatus, measurement data representing intensity of vibration generated on the road R1 as a graph of a distance of an optical fiber from the sensing apparatus and a time, as measurement data of the vibration generated on the road R1 (step X21).

Next, the extraction unit 12 performs frequency filtering on the measurement data by using a band limiting filter having a passband selected in advance by the selection unit 13A according to the road R1 and the road surface state r1 of the road R1. As a result, the extraction unit 12 extracts a vehicle vibration component from the measurement data (step X22).

Thereafter, the extraction unit 12 outputs data of the vehicle vibration component extracted from the measurement data as vehicle vibration extraction data (step X23).

Subsequently, an example of a flow of schematic operation of the vehicle vibration extraction system 1A will be described with reference to FIG. 7.

In the pre-selection phase, the selection unit 13A selects in advance a passband at a time when a road is in a road surface state for each road and for each road surface state of the road (step S21). Specifically, the selection unit 13A selects, for each road and for each road surface state of the road, the passband, based on the vibration propagation characteristic of the road at a time when the road is in the road surface state. Alternatively, the selection unit 13A selects, for each road and for each road surface state of the road, the passband, based on the vibration propagation characteristic of the road and the vibration characteristic of a vehicle at a time when the road is in the road surface state.

In the subsequent operation phase, first, the acquisition unit 11 acquires, from the sensing apparatus, measurement data representing the intensity of the vibration generated on the road R1 as a graph of the distance of the optical fiber from the sensing apparatus and a time, as measurement data of the vibration generated on the road R1 (step S22).

Thereafter, the extraction unit 12 extracts the vehicle vibration component from the measurement data by performing frequency filtering on the measurement data by using a band limiting filter having the passband previously selected by the selection unit 13A according to the road R1 and the road surface state r1 of the road R1 (step S23).

As described above, according to the second example embodiment, the selection unit 13A selects in advance, for each road and for each road surface state of the road, a passband at a time when the road is in the road surface state. Specifically, the selection unit 13A selects, for each road and for each road surface state of the road, the passband, based on the vibration propagation characteristic of the road at a time when the road is in the road surface state. Alternatively, the selection unit 13A selects, for each road and for each road surface state of the road, the passband, based on the vibration propagation characteristic of the road and the vibration characteristic of a vehicle at a time when the road is in the road surface state. As a result, an optimum band limiting filter associated to the road and the road surface state of the road can be selected in advance.

Another advantageous effect is similar to that of the first example embodiment described above.

Note that, for example, there is a road, such as an expressway X in FIG. 1, in which a large number of tunnel portions are included, and a frequency in which the vehicle vibration component is dominant does not depend on the road surface state. For such a road, regardless of the road surface state of the road, the selection unit 13A may select only one passband of the road, and does not necessary to select the passband for each road surface state of the road (the same applies to the following third and fourth example embodiments).

### Third Example Embodiment

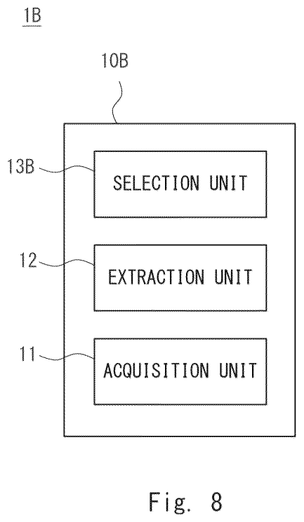

First, a schematic configuration example of a vehicle vibration extraction system 1B will be described with reference to FIG. 8.

The vehicle vibration extraction system 1B includes a vehicle vibration extraction apparatus 10B.

The vehicle vibration extraction apparatus 10B has a configuration in which the selection unit 13A is replaced with a selection unit 13B as compared with the vehicle vibration extraction apparatus 10A.

The selection unit 13B selects in advance a passband at a time when a road is in a road surface state for each road and for each road surface state of the road.

Herein, the selection unit 13B will be described specifically.

First, an acquisition unit 11 acquires, from a sensing apparatus for each road and for each road surface state of the road, measurement data at a time when the road is in the road surface state. The measurement data are measurement data in which intensity of vibration generated when the road is in the road surface state is represented as a graph of a distance of an optical fiber from the sensing apparatus and a time.

Next, the selection unit 13B divides, into each band, the measurement data at a time when a road is in a road surface state for each road and for each road surface state of the road. Then, the selection unit 13B aggregates the number of oblique lines representing that a vehicle is traveling on the road with respect to the measurement data of each divided band. Then, the selection unit 13B selects a passband at a time when the road is in the road surface state, based on the aggregated number of the oblique lines.

At this time, in the measurement data, an inclination of the oblique line is equivalent to a traveling speed of a vehicle, as described above. Therefore, the selection unit 13B may aggregate the number of oblique lines having the same degree of inclination (i.e., the same degree of traveling speed).

Further, the selection unit 13B may select, for each road and for each road surface state of the road, a band in which the number of oblique lines becomes a maximum number as a result of aggregating the number of oblique lines with respect to the measurement data of each divided band, as the passband at a time when the road is in the road surface state.

Alternatively, the selection unit 13B may select, for each road and for each road surface state of the road, a band having the number of oblique lines equal to or greater than a threshold value, in a case where there is one band having the number of oblique lines equal to or greater than the threshold value, as a result of aggregating the number of oblique lines with respect to the measurement data of each divided band, as the passband at a time when the road is in the road surface state. Further, in a case where there are a plurality of bands having the number of oblique lines equal to or greater than the threshold value, the selection unit 13B may select a band acquired by combining a plurality of bands having the number of oblique lines equal to or greater than the threshold value, as the passband at a time when the road is in the road surface state.

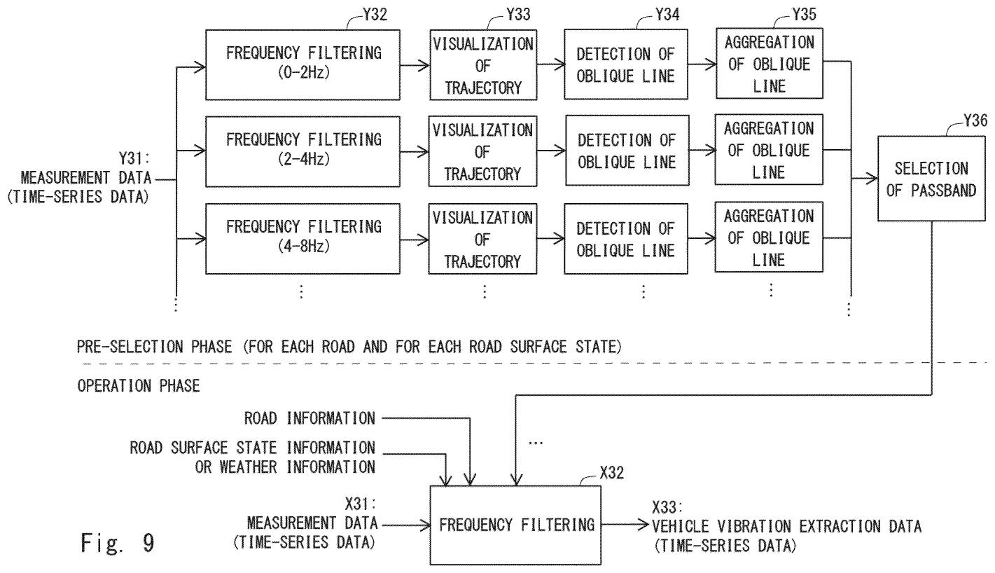

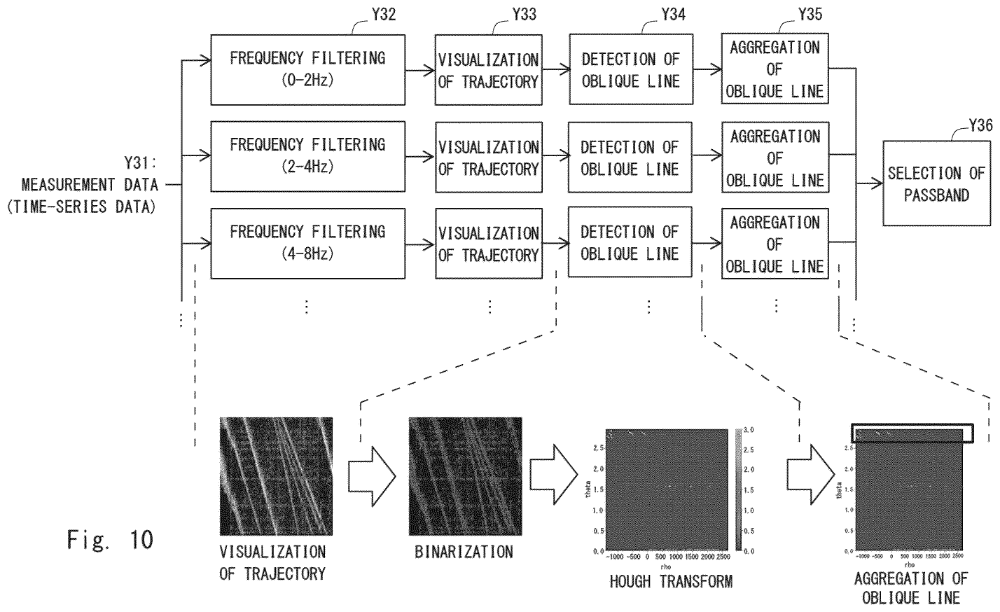

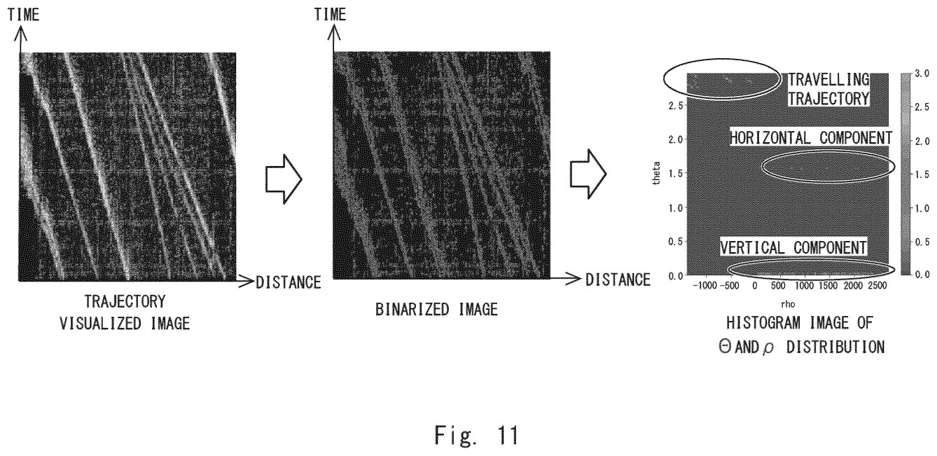

Subsequently, a schematic operation example of the vehicle vibration extraction system 1B will be described with reference to FIGS. 9 to 11. Note that, FIG. 10 illustrates an example of an image transition of measurement data in each step of a pre-selection phase in FIG. 9. Further, FIG. 11 illustrates an example of an enlarged view of a trajectory visualized image, a binarized image, and a histogram image of θ and ρ after Hough transform in FIG. 10.

First, operation of the pre-selection phase will be described.

First, the acquisition unit 11 acquires, from the sensing apparatus for each road and for each road surface state of the road, measurement data at a time when the road is in the road surface state (step Y31).

Thereafter, the selection unit 13B selects a passband at a time when a road is in a road surface state for each road and for each road surface state of the road.

For example, the selection unit 13B selects the passband at a time when a road R1 is in a road surface state r1 as follows.

First, the selection unit 13B divides, into each band, the measurement data at a time when the road R1 is in the road surface state r1 (step Y32). Herein, the measurement data are subjected to frequency filtering and divided into each band of 0-2 Hz band, 2-4 Hz band, 4-8 Hz band, . . . . As a result, an image of the measurement data of each divided band is converted into a trajectory visualized image in which a trajectory of a vehicle is visualized (step Y33).

Next, the selection unit 13B converts the trajectory visualized image of the measurement data of each divided band into a binarized image by binarizing the trajectory visualized image, performs the Hough transform on the converted binarized image, and detects an oblique line by using a histogram image of θ and ρ after the Hough transform (step Y34).

Herein, in the histogram image of θ and ρ after the Hough transform, θ is equivalent to an inclination angle of an oblique line. A trajectory of a vehicle is concentrated at approximately the same degree of θ (in this case, in a vicinity of θ=2.7 to 2.9). On the other hand, a component of a horizontal or vertical line in the measurement data appears in the vicinity of θ=0 and π/2 (˜1.57).

Therefore, the selection unit 13B aggregates the number of oblique lines in the vicinity of θ=2.7 to 2.9 (step Y35).

Thereafter, the selection unit 13B selects the passband at a time when the road R1 is in the road surface state r1, based on the aggregated number of the oblique lines (step Y36).

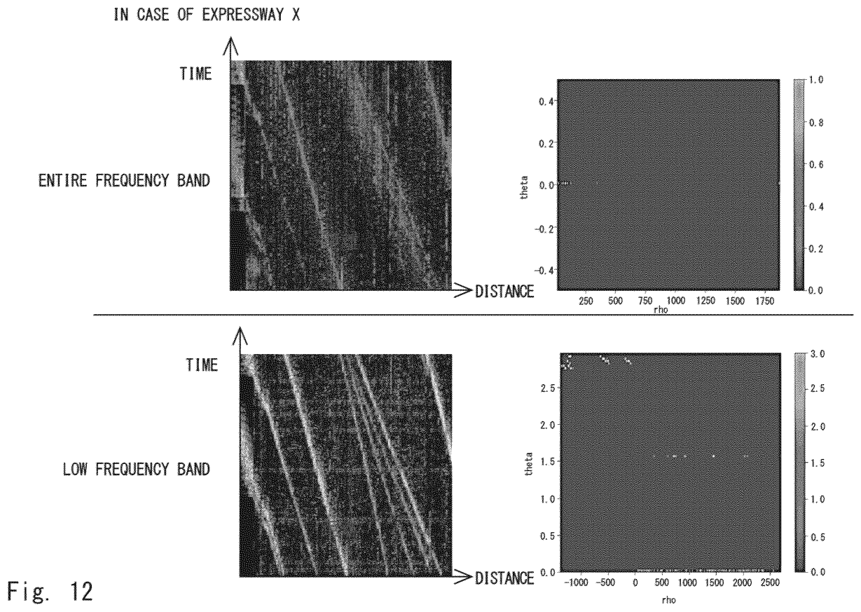

Herein, an upper figure in FIG. 12 illustrates an example of the trajectory visualized image and the histogram image after the Hough transform that are acquired without band-dividing the measurement data of the entire frequency band in a case where the road R1 is an expressway X. Further, a lower figure in FIG. 12 illustrates an example of the trajectory visualized image and the histogram image after the Hough transform acquired by dividing the measurement data into low frequency bands in a case where the road R1 is the expressway X. In this way, it can be seen that a large number of oblique lines can be acquired in the measurement data of the low frequency band.

Therefore, in the example in FIG. 12, the selection unit 13B selects the low frequency band as the passband at a time when the road R1 is the expressway X, for example.

The selection unit 13B performs the above-described passband selection operation for each road and for each road surface state of the road.

Note that, operation of an operation phase in FIG. 9 (steps X31 to X33) in the vehicle vibration extraction system 1B is similar to the operation of the operation phase in FIG. 6 (steps X21 to X23) in the vehicle vibration extraction system 1A described above, and thus description thereof is omitted.

Further, a flow of the operation in the vehicle vibration extraction system 1B is also similar to the flow of the operation in FIG. 7 (steps S21 to S23) in the vehicle vibration extraction system 1A described above, and thus the description thereof is omitted.

As described above, according to the third example embodiment, the selection unit 13B selects in advance, for each road and for each road surface state of the road, a passband at a time when the road is in the road surface state. Specifically, the acquisition unit 11 acquires, for each road and for each road surface state of the road, measurement data at a time when the road is in the road surface state. The selection unit 13B divides, for each road and for each road surface state of the road, measurement data at a time when the road is in the road surface state, into each band, aggregates the number of oblique lines with respect to the measurement data of each divided band, and selects the passband, based on the aggregated number of oblique lines. As a result, an optimum band limiting filter associated to the road and the road surface state of the road can be selected in advance.

Another advantageous effect is similar to that of the first example embodiment described above.

### Fourth Example Embodiment

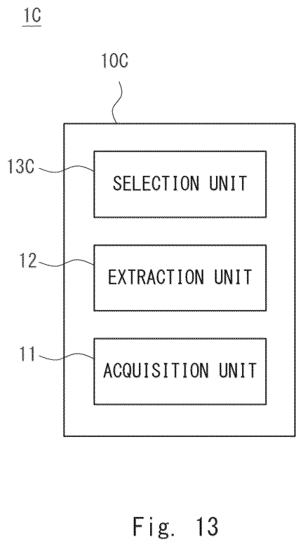

First, a schematic configuration example of a vehicle vibration extraction system 1C will be described with reference to FIG. 13.

The vehicle vibration extraction system 1C includes a vehicle vibration extraction apparatus 10C.

The vehicle vibration extraction apparatus 10C has a configuration in which the selection unit 13A is replaced with a selection unit 13C as compared with the vehicle vibration extraction apparatus 10A.

The selection unit 13C selects in advance a passband at a time when a road is in a road surface state for each road and for each road surface state of the road.

Herein, the selection unit 13C will be described specifically.

First, an acquisition unit 11 acquires, from a sensing apparatus for each road and for each road surface state of the road, measurement data at a time when the road is in the road surface state. The measurement data are measurement data in which intensity of vibration generated when the road is in the road surface state is represented as a graph of a distance of an optical fiber from the sensing apparatus and a time.

Next, the selection unit 13C cuts out, for each road and for each road surface state of the road, measurement data at a time when a vehicle is traveling on the road and measurement data at a time when a vehicle is not traveling on the road, from measurement data at a time when the road is in the road surface state. Then, the selection unit 13C calculates a power difference (i.e., a difference in vibration intensity), in a frequency domain, between the two pieces of cut-out measurement data, and selects a passband at a time when the road is in the road surface state, based on the calculated power difference.

At this time, the selection unit 13C may use camera information of a camera installed on a road and synchronized with the vehicle vibration extraction system 1C for determining whether a vehicle is traveling or not traveling on the road.

Further, the selection unit 13C may select, for each road and for each road surface state of the road, a band in which the calculated power difference becomes a maximum value as a result of calculating the power difference, as the passband at a time when the road is in the road surface state.

Alternatively, the selection unit 13C may select, for each road and for each road surface state of the road, a band having the power difference equal to or greater than a threshold value, in a case where there is one band having the power difference equal to or greater than the threshold value, as a result of calculating the power difference, as the passband at a time when the road is in the road surface state. Further, in a case where there are a plurality of bands having the power difference equal to or greater than the threshold value, the selection unit 13C may select a band acquired by combining a plurality of bands having the power difference equal to or greater than the threshold value, as the passband at a time when the road is in the road surface state.

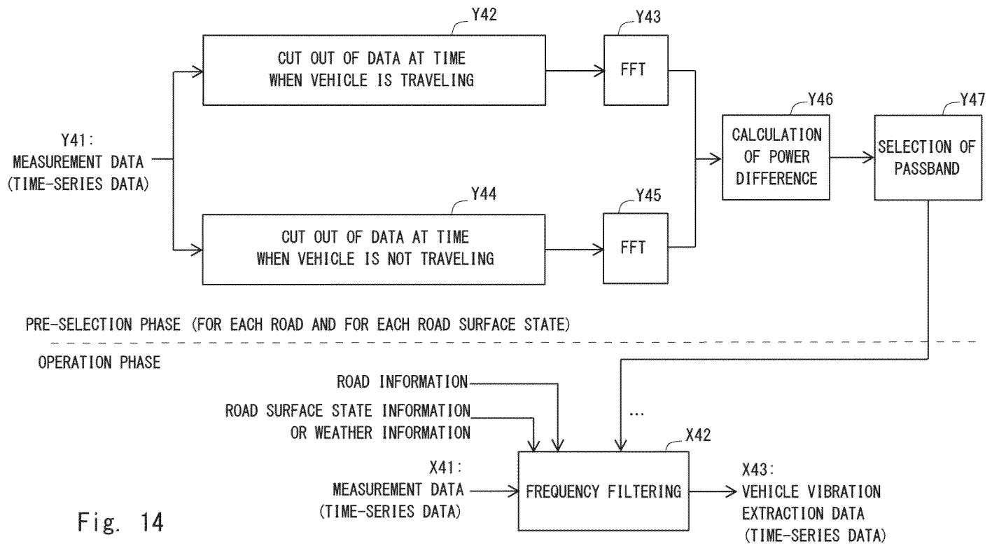

Subsequently, a schematic operation example of the vehicle vibration extraction system 1C will be described with reference to FIG. 14.

First, operation of a pre-selection phase will be described.

First, the acquisition unit 11 acquires, from the sensing apparatus for each road and for each road surface state of the road, measurement data at a time when the road is in the road surface state (step Y41).

Thereafter, the selection unit 13C selects a passband at a time when road is in a road surface state for each road and for each road surface state of the road.

For example, the selection unit 13C selects the passband at a time when a road R1 is in a road surface state r1 as follows.

First, the selection unit 13C cuts out the measurement data at a time when a vehicle is traveling on the road R1 from the measurement data at a time when the road R1 is in the road surface state r1 (step Y42), and cuts out the measurement data at a time when a vehicle is not traveling on the road R1 (step Y44).

Next, the selection unit 13C performs fast Fourier transform (FFT) on the measurement data at a time when a vehicle is traveling on the road R1 (step Y43), and also performs FFT on the measurement data at a time when a vehicle is not traveling on the road R1 (step Y45).

Next, the selection unit 13C calculates a power difference (i.e., a difference in vibration intensity), in a frequency domain, between the two pieces of measurement data subjected to FFT (step Y46).

Thereafter, the selection unit 13C selects the passband at a time when the road R1 is in the road surface state r1, based on the calculated power difference.

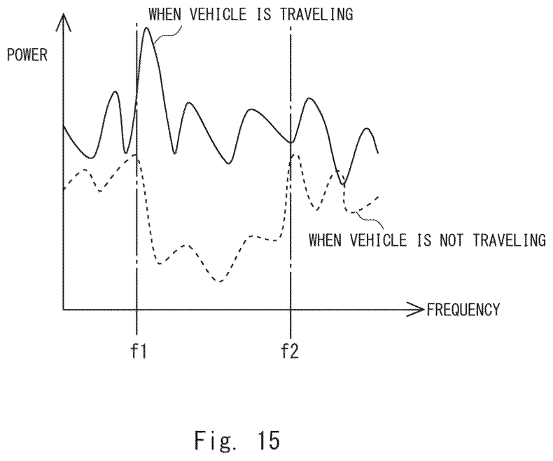

Herein, FIG. 15 illustrates an example of a power difference (i.e., a difference in vibration intensity), in the frequency domain, between the measurement data when a vehicle is traveling and when a vehicle is not traveling at a time when the road R1 is in the road surface state r1. In FIG. 15, a horizontal axis illustrates a frequency, and a vertical axis represents power (vibration intensity).

In the example in FIG. 15, it can be seen that the power difference increases in the band of f1 to f2.

Therefore, in the example in FIG. 15, for example, the selection unit 13C selects the band of f1 to f2 as the passband at a time when the road R1 is in the road surface state r1.

The selection unit 13C performs the above-described passband selection operation for each road and for each road surface state of the road.

Note that, operation of an operation phase in FIG. 14 (steps X41 to X43) in the vehicle vibration extraction system 1C is similar to the operation of the operation phase in FIG. 6 (steps X21 to X23) in the vehicle vibration extraction system 1A described above, and thus description thereof is omitted.

Further, a flow of the operation in the vehicle vibration extraction system 1C is also similar to the flow of the operation in FIG. 7 (steps S21 to S23) in the vehicle vibration extraction system 1A described above, and thus the description thereof is omitted.

As described above, according to the fourth example embodiment, the selection unit 13C selects in advance, for each road and for each road surface state of the road, a passband at a time when the road is in the road surface state. Specifically, the acquisition unit 11 acquires, for each road and for each road surface state of the road, measurement data at a time when the road is in the road surface state. The selection unit 13C cuts out, for each road and for each road surface state of the road, measurement data at a time when a vehicle is traveling on the road and measurement data at a time when a vehicle is not traveling on the road, from the measurement data at a time when the road is in the road surface state, calculates a power difference (difference in vibration intensity), in a frequency domain, between the two pieces of cut-out measurement data, and selects the passband, based on the calculated power difference. As a result, an optimum band limiting filter associated to the road and the road surface state of the road can be selected in advance.

Another advantageous effect is similar to that of the first example embodiment described above.

### Another Example Embodiment

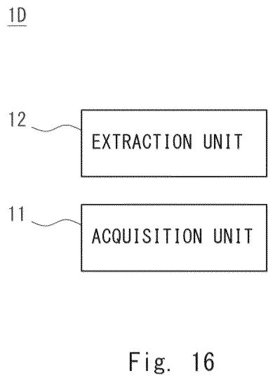

In the first to fourth example embodiments described above, the acquisition unit 11, the extraction unit 12, and the selection units 13A, 13B, and 13C are provided inside the vehicle vibration extraction apparatuses 10, 10A, 10B, and 10C, but the present invention is not limited thereto. The acquisition unit 11, the extraction unit 12, and the selection units 13A, 13B, and 13C may be provided in apparatuses different from each other, or may be provided on a cloud. FIG. 16 illustrates a configuration example of a vehicle vibration extraction system 1D in which an acquisition unit 11 and an extraction unit 12 are provided in apparatuses different from each other or on a cloud. Note that, in the vehicle vibration extraction system 1D illustrated in FIG. 16, the selection units 13A, 13B, and 13C in the vehicle vibration extraction apparatuses 10A, 10B, and 10C described above may be additionally provided.

### Hardware Configuration of Vehicle Vibration Extraction Apparatus According to Example Embodiment

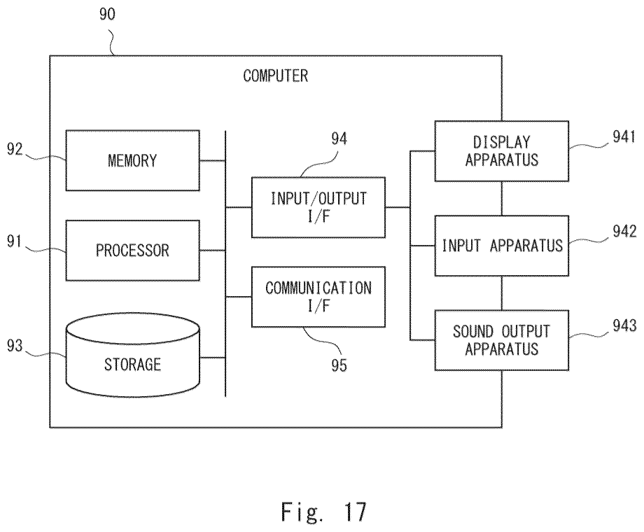

Subsequently, with reference to FIG. 17, a hardware configuration example of a computer that achieves the above-described vehicle vibration extraction apparatuses 10, 10A, 10B, and 10C will be described.

As illustrated in FIG. 17, a computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected by a data transmission line for transmitting and receiving data to and from one another.

The processor 91 is, for example, an arithmetic processing apparatus such as a central processing unit (CPU) or a graphics processing unit (GPU). The memory 92 is, for example, a memory such as a random access memory (RAM) or a read only memory (ROM). The storage 93 is, for example, a storage apparatus such as a hard disk drive (HDD), a solid state drive (SSD), or a memory card. Further, the storage 93 may be a memory such as a RAM or a ROM.

A program is stored in the storage 93. The program includes instructions (or a software code) for causing the computer 90 to execute one or more functions in the vehicle vibration extraction apparatuses 10, 10A, 10B, and 10C described above when loaded into the computer. A component in the vehicle vibration extraction apparatuses 10, 10A, 10B, and 10C described above may be achieved by the processor 91 reading and executing a program stored in the storage 93. Further, a storage function in the vehicle vibration extraction apparatuses 10, 10A, 10B, and 10C described above may be achieved by the memory 92 or the storage 93.

Further, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The input/output interface 94 is connected to a display apparatus 941, an input apparatus 942, a sound output apparatus 943, and the like. The display apparatus 941 is an apparatus, such as a liquid crystal display (LCD), a cathode ray tube (CRT) display, or a monitor, that displays a screen associated to drawing data processed by the processor 91. The input apparatus 942 is an apparatus that accepts an operation input from an operator, and is, for example, a keyboard, a mouse, a touch sensor, and the like. The display apparatus 941 and the input apparatus 942 may be integrated and achieved as a touch panel. The sound output apparatus 943 is an apparatus, such as a speaker, that acoustic-outputs sound associated to acoustic data processed by the processor 91.

The communication interface 95 transmits and receives data to and from an external apparatus. For example, the communication interface 95 communicates with an external apparatus via a wired communication line or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### Supplementary Note 1

A vehicle vibration extraction system including:
at least one memory configured to store instructions; and
at least one processor configured, by executing the instructions, to
acquire measurement data of vibration generated on a road from a sensing apparatus that measures vibration generated on the road by using an optical fiber buried in the road, and
extract a vehicle vibration component from the measurement data by performing frequency filtering on the measurement data by using a band limiting filter having a passband associated to the road and a road surface state of the road.

### Supplementary Note 2

The vehicle vibration extraction system according to supplementary note 1, wherein the at least one processor is configured to
select in advance a passband at a time when the road is in the road surface state for each road and for each road surface state of the road, and
perform frequency filtering on the measurement data by using a band limiting filter having a passband selected in advance according to the road and the road surface state of the road.

### Supplementary Note 3

The vehicle vibration extraction system according to supplementary note 2, wherein the at least one processor is configured to select, for each road and for each road surface state of the road, the passband, based on a vibration propagation characteristic of the road at a time when the road is in the road surface state.

### Supplementary Note 4

The vehicle vibration extraction system according to supplementary note 2, wherein the at least one processor is configured to select, for each road and for each road surface state of the road, the passband, based on a vibration propagation characteristic of the road and a vibration characteristic of a vehicle at a time when the road is in the road surface state.

### Supplementary Note 5

The vehicle vibration extraction system according to supplementary note 2, wherein the at least one processor is configured to
acquire, for each road and for each road surface state of the road, measurement data representing intensity of vibration generated on the road as a graph of a distance of the optical fiber from the sensing apparatus and a time, as the measurement data at a time when the road is in the road surface state, and
divide, for each road and for each road surface state of the road, the measurement data at a time when the road is in the road surface state into each band, aggregate the number of oblique lines with respect to the measurement data of each divided band, and select the passband, based on the aggregated number of oblique lines.

### Supplementary Note 6

The vehicle vibration extraction system according to supplementary note 5, wherein the at least one processor is configured to select, for each road and for each road surface state of the road, a band in which the number of the oblique lines becomes a maximum number as a result of aggregating the number of the oblique lines, as the passband.

### Supplementary Note 7

The vehicle vibration extraction system according to supplementary note 5, wherein the at least one processor is configured to select, for each road and for each road surface state of the road, a band having the number of the oblique lines equal to or greater than a threshold value, in a case where there is one band having the number of the oblique lines equal to or greater than a threshold value, as a result of aggregating the number of the oblique lines, as the passband, and select a band acquired by combining a plurality of bands having the number of the oblique lines equal to or greater than a threshold value, as the passband, in a case where there are a plurality of bands having the number of the oblique lines equal to or greater than a threshold value.

### Supplementary Note 8

The vehicle vibration extraction system according to supplementary note 5, wherein the at least one processor is configured to perform, for each road and for each road surface state of the road, Hough transform on the measurement data of each divided band, and aggregate the number of the oblique lines by using a Hough-transformed image.

### Supplementary Note 9

The vehicle vibration extraction system according to supplementary note 2, wherein the at least one processor is configured to
acquire, for each road and for each road surface state of the road, measurement data representing intensity of vibration generated on the road as a graph of a distance of the optical fiber from the sensing apparatus and a time, as the measurement data at a time when the road is in the road surface state, and
cut out, for each road and for each road surface state of the road, measurement data at a time when a vehicle is traveling on the road and measurement data at a time when a vehicle is not traveling on the road, from the measurement data at a time when the road is in the road surface state, calculate a difference in vibration intensity, in a frequency domain, between the two pieces of cut-out measurement data, and select the passband, based on the calculated difference in vibration intensity.

### Supplementary Note 10

The vehicle vibration extraction system according to supplementary note 9, wherein the at least one processor is configured to select, for each road and for each road surface state of the road, a band in which a calculated difference in vibration intensity becomes a maximum value as a result of calculating the difference in the vibration intensity, as the passband.

### Supplementary Note 11

The vehicle vibration extraction system according to supplementary note 9, wherein the at least one processor is configured to select, for each road and for each road surface state of the road, a band having the difference in the vibration intensity equal to or greater than a threshold value, in a case where there is one band having the difference in the vibration intensity equal to or greater than a threshold value, as a result of calculating the difference in the vibration intensity, as the passband, and select a band acquired by combining a plurality of bands having the difference in the vibration intensity equal to or greater than a threshold value, as the passband, in a case where there are a plurality of bands having the difference in the vibration intensity equal to or greater than a threshold value.

### Supplementary Note 12

The vehicle vibration extraction system according to supplementary note 1, wherein the at least one processor is configured to input weather information of an area including the road, and determine a road surface state of the road, based on the input weather information.

### Supplementary Note 13

The vehicle vibration extraction system according to supplementary note 1, wherein the at least one processor is configured to include a plurality of band limiting filters having passbands different from each other, and select and use a band limiting filter having a passband associated to the road and a road surface state of the road from among the plurality of band limiting filters.

### Supplementary Note 14

A vehicle vibration extraction apparatus including:
at least one memory configured to store instructions; and
at least one processor configured, by executing the instructions, to
acquire measurement data of vibration generated on a road from a sensing apparatus that measures vibration generated on the road by using an optical fiber buried in the road, and
extract a vehicle vibration component from the measurement data by performing frequency filtering on the measurement data by using a band limiting filter having a passband associated to the road and a road surface state of the road.

### Supplementary Note 15

A vehicle vibration extraction method executed by a vehicle vibration extraction apparatus, the vehicle vibration extraction method including:
acquiring measurement data of vibration generated on a road from a sensing apparatus that measures vibration generated on the road by using an optical fiber buried in the road; and
extracting a vehicle vibration component from the measurement data by performing frequency filtering on the measurement data by using a band limiting filter having a passband associated to the road and a road surface state of the road.

Note that, some or all of elements (e.g., structures and functions) specified in Supplementary Notes 2 to 13 dependent on Supplementary Note 1 may also be dependent on Supplementary Note 14 and Supplementary Note 15 in dependency similar to that of Supplementary Notes 2 to 13 dependent on Supplementary Note 1. Some or all of elements specified in any of Supplementary Notes may be applied to various types of hardware, software, and recording means for recording software, systems, and methods.

An example advantage according to the above-described example embodiments is that it is possible to provide a vehicle vibration extraction system, a vehicle vibration extraction apparatus, and a vehicle vibration extraction method that are capable of extracting a vehicle vibration component with high accuracy from measurement data of vibration measured by optical fiber sensing.

What is claimed is:

1. A vehicle vibration extraction system comprising:
at least one memory configured to store instructions; and
at least one processor configured, by executing the instructions, to
acquire measurement data of vibration generated on a road from a sensing apparatus that measures vibration generated on the road by using an optical fiber buried in the road, and
extract a vehicle vibration component from the measurement data by performing frequency filtering on the measurement data by using a band limiting filter having a passband associated to the road and a road surface state of the road.

2. The vehicle vibration extraction system according to claim 1, wherein the at least one processor is configured to
select in advance a passband at a time when the road is in the road surface state for each road and for each road surface state of the road, and
perform frequency filtering on the measurement data by using a band limiting filter having a passband selected in advance according to the road and the road surface state of the road.

3. The vehicle vibration extraction system according to claim 2, wherein the at least one processor is configured to select, for each road and for each road surface state of the road, the passband, based on a vibration propagation characteristic of the road at a time when the road is in the road surface state.

4. The vehicle vibration extraction system according to claim 2, wherein the at least one processor is configured to select, for each road and for each road surface state of the road, the passband, based on a vibration propagation characteristic of the road and a vibration characteristic of a vehicle at a time when the road is in the road surface state.

5. The vehicle vibration extraction system according to claim 2, wherein the at least one processor is configured to
acquire, for each road and for each road surface state of the road, measurement data representing intensity of vibration generated on the road as a graph of a distance of the optical fiber from the sensing apparatus and a time, as the measurement data at a time when the road is in the road surface state, and
divide, for each road and for each road surface state of the road, the measurement data at a time when the road is in the road surface state into each band, aggregate the number of oblique lines with respect to the measurement data of each divided band, and select the passband, based on the aggregated number of oblique lines.

6. The vehicle vibration extraction system according to claim 5, wherein the at least one processor is configured to select, for each road and for each road surface state of the road, a band in which the number of the oblique lines becomes a maximum number as a result of aggregating the number of the oblique lines, as the passband.

7. The vehicle vibration extraction system according to claim 5, wherein the at least one processor is configured to select, for each road and for each road surface state of the road, a band having the number of the oblique lines equal to or greater than a threshold value, in a case where there is one band having the number of the oblique lines equal to or greater than a threshold value, as a result of aggregating the number of the oblique lines, as the passband, and select a band acquired by combining a plurality of bands having the number of the oblique lines equal to or greater than a threshold value, as the passband, in a case where there are a plurality of bands having the number of the oblique lines equal to or greater than a threshold value.

8. The vehicle vibration extraction system according to claim 5, wherein the at least one processor is configured to perform, for each road and for each road surface state of the road, Hough transform on the measurement data of each divided band, and aggregate the number of the oblique lines by using a Hough-transformed image.

9. The vehicle vibration extraction system according to claim 2, wherein the at least one processor is configured to
acquire, for each road and for each road surface state of the road, measurement data representing intensity of vibration generated on the road as a graph of a distance of the optical fiber from the sensing apparatus and a time, as the measurement data at a time when the road is in the road surface state, and
cut out, for each road and for each road surface state of the road, measurement data at a time when a vehicle is traveling on the road and measurement data at a time when a vehicle is not traveling on the road, from the measurement data at a time when the road is in the road surface state, calculate a difference in vibration intensity, in a frequency domain, between the two pieces of cut-out measurement data, and select the passband, based on the calculated difference in vibration intensity.

10. The vehicle vibration extraction system according to claim 9, wherein the at least one processor is configured to select, for each road and for each road surface state of the road, a band in which a calculated difference in vibration intensity becomes a maximum value as a result of calculating the difference in the vibration intensity, as the passband.

11. The vehicle vibration extraction system according to claim 9, wherein the at least one processor is configured to select, for each road and for each road surface state of the road, a band having the difference in the vibration intensity equal to or greater than a threshold value, in a case where there is one band having the difference in the vibration intensity equal to or greater than a threshold value, as a result of calculating the difference in the vibration intensity, as the passband, and select a band acquired by combining a plurality of bands having the difference in the vibration intensity equal to or greater than a threshold value, as the passband, in a case where there are a plurality of bands having the difference in the vibration intensity equal to or greater than a threshold value.

12. The vehicle vibration extraction system according to claim 1, wherein the at least one processor is configured to input weather information of an area including the road, and determine a road surface state of the road, based on the input weather information.

13. The vehicle vibration extraction system according to claim 1, wherein the at least one processor is configured to include a plurality of band limiting filters having passbands different from each other, and select and use a band limiting filter having a passband associated to the road and a road surface state of the road from among the plurality of band limiting filters.

14. A vehicle vibration extraction apparatus comprising:
at least one memory configured to store instructions; and
at least one processor configured, by executing the instructions, to
acquire measurement data of vibration generated on a road from a sensing apparatus that measures vibration generated on the road by using an optical fiber buried in the road, and
extract a vehicle vibration component from the measurement data by performing frequency filtering on the measurement data by using a band limiting filter having a passband associated to the road and a road surface state of the road.

15. A vehicle vibration extraction method executed by a vehicle vibration extraction apparatus, the vehicle vibration extraction method comprising:
acquiring measurement data of vibration generated on a road from a sensing apparatus that measures vibration generated on the road by using an optical fiber buried in the road; and
extracting a vehicle vibration component from the measurement data by performing frequency filtering on the measurement data by using a band limiting filter having a passband associated to the road and a road surface state of the road.
